(19) United States
(12) Patent Application Publication
(10) Pub. No.: US 2018/0062747 A1
(43) Pub. Date: Mar. 1, 2018

(54) Optical Communication Module

(71) Applicant: MACOM Technology Solutions Holdings, Inc., Lowell, MA (US)

(72) Inventors: Atul Gupta, Aliso Viejo, CA (US); Marek Tlalka, San Marcos, CA (US)

(21) Appl. No.: 15/688,677

(22) Filed: Aug. 28, 2017

Related U.S. Application Data
(60) Provisional application No. 62/380,186, filed on Aug. 26, 2016.

(51) Int. Cl. H04B 10/40; G02B 6/42; H04B 10/25; H04B 10/58; H04B 10/69; H04L 25/03

(52) U.S. Cl. CPC H04B 10/40; G02B 6/4292; G02B 6/4246; G02B 6/4274; H04L 25/03057; H04B 10/58; H04B 10/6971; H04L 25/03885; H04B 10/2503

(57) ABSTRACT

An optic module for use with a host is disclosed that includes a port configured to accept an optical connector connected to fiber optic cables which carry optic signals. A receiver module is configured to receive an incoming optic signal and convert the received optic signal to a received electrical signal while a transimpedance amplifier amplifies the received electrical signal. An electrical interface is configured to electrically interface the optic module with the host thereby providing the amplified received electrical signal to a digital signal processor in the host. On the transmit side, an optic device driver receives an outgoing electrical signal from the host, after processing by a digital signal processor in the host, for amplification while a transmit module is configured to convert the outgoing electrical signal to an outgoing optic signal and transmit the outgoing optic signal on an optic fiber.

### PRIORITY CLAIM

This application claims priority to and the benefit of U.S. Provisional Application No. 62/380,186 filed on Aug. 26, 2016 entitled Optimal Communication Mode.

### FIELD OF THE INVENTION

The invention relates to optical communication module and in particular to an optical communication module with digital signal processing elements located in the network device while additional signal processing occurs in the module.

### RELATED ART

FIG. 1 illustrates an example environment of use of the innovations disclosed herein. As shown, a switch, router, computer, server or other electronic devices 104 capable of data communication is provided with one or more ports 108 or slots. An optic module 112, 116 is configured to slide into and electrically connect to the host 104 to effect data communication. Fiber optic cables connect to the module 112, 116 to provide an optical signal to the module 116. In operation, the optic signal from the fiber 120 is presented to the optic modules 112, 116 which in turn converts the optical signal to an electrical signal. The electrical signal is presented to the device 104.

FIG. 2 is an exemplary optic module 204 that slides into a data communication device. The module includes an electrical interface 208 and an optic fiber interface 212.

FIG. 3 illustrates a prior art optic module and communication device. As shown, the module 312 slides into a slot or port 308 on the communication device 304. The optic module includes an optical transmitter and an optical receiver. The output of the optical receiver feeds into a TIA and then into a digital signal processor (DSP) or other signal processing element that is part of the module. The output of the DSP connects to an electrical connector and the signal is provided to an ASIC (application specific integrated circuit). The transmit path includes the DSP, then a driver and the optical transmitter. Fiber optic cables connect to the optical transmitter and optical receiver.

Several problems exist in the prior art. Placing the DSP as in the optic module causes the optic module to consume excessive power. For example, with the DSP in the optic module 312 up to or more than 7 watts may be consumed, which creates excess heat and power sourcing demands. In addition, the price of the module is increased by including the costly DSP in the module. For example, if the DSP costs $10 to make, then it may be sold for $16 to the optic module manufacturer. Then this module is sold to a customer and the entire module undergoes another price mark up, causing the price for just the DSP to rise to $24 for the customer. This is known as margin stacking. By removing DSP from module and putting it in the computer, near the connector, it is not part of the module and thus does not consume so much module power, and margin stacking does not occur for the module.

### SUMMARY

To overcome the drawbacks of the prior art and provide additional benefits, an optic module and host are disclosed which are configured for data communication. In on embodiment, this system includes an optic module with an outer housing having an interior space. A port in the housing is configured receive an optical connector. The optical connector attaches to a fiber optic cable which carries an optic signal. Inside the housing is a receiving optic unit configured to receive and convert the optic signal to a received electrical signal. A transimpedance amplifier amplifies the receiver signal to create an amplified signal and provides the amplified incoming signal to the host for processing by a digital signal processing.

Also part of this embodiment is a driver configured to receive and amplify an outgoing electrical signal that is to be transmitted as an electrical signal. The outgoing electrical signal is received from the host. A transmit optic unit is configured to receive and convert the amplifier version of the outgoing electrical signal from the driver to an optic signal. The optic signal is transmitted from the transmitter optic unit.

A host is also part of this system and it includes a port having an electrical interface such that the port is configured to receive the optic module and establish an electrical connection to the optic module. Inside the host is a digital signal processor that is configured to receive and process the incoming electrical signal over the electrical interface from the optic module. The digital signal processor processes the data signal to create the outgoing electrical signal and provide the outgoing electrical signal to the optic module through the electrical interface.

In one embodiment, the digital signal processor performs feed forward equalization, decision feedback equalization, or both. The digital signal processor in the host may be shared between two or more optic modules thereby reducing the number of digital signal processors required support a number of optic modules. It is contemplated that the transimpedance amplifier may further include a de-emphasis module configured to de-emphasis certain frequencies of the receiver signal. Similarly, the driver amplifier may further include an equalization module configured to de-emphasis certain frequencies of the outgoing electrical signal. Some embodiments include both de-emphasis in the TIA and equalization in the driver. In one embodiment, the digital signal processor is in the host and as such the optic module does not include a digital signal processor. The host may comprise any of the following devices: server, switch, router, hub, microprocessor, network access point, or any other data communication device.

Also, disclosed herein is an optic module for use with a host that includes a port configured to accept an optical connector. The optical connector is connected to one or more fiber optic cables which carry incoming optic signals and outgoing optic signals. A receiver module receives an incoming optic signal and converts the received optic signal to a received electrical signal. A transimpedance amplifier amplifies the received electrical signal and provides the amplified version to an electrical interface. The electrical interface electrically interface and connects the optic module with the host thereby providing the amplified received electrical signal to a digital signal processor in the host.

Also, part of this embodiment is an optic device driver configured to receive an outgoing electrical signal from the host after processing by a digital signal processor in the host. This signal is received over the electrical interface such that the optic device driver is configured to amplify outgoing electrical signals. A transmit module receives the amplified outgoing electrical signal from the driver. The transmit module is configured to receive the outgoing electrical signal from the optic device driver, convert the outgoing electrical signal to an outgoing optic signal, and then transmit the outgoing optic signal on to an optic cable fiber associated with the optical connector.

In one embodiment, the optic module shares the digital signal processor located in the host with one or more other optic modules. The transimpedance amplifier may be configured with a de-emphasis module that is configured to apply de-emphasis to certain frequencies of the receiver signal. The optic device driver may also include an equalization module configured to equalize certain frequencies of the outgoing electrical signal. To reduce cost and provide other benefits, in one configuration the optic module does not include a digital signal processor. As discussed herein the host may be one of the following devices: server, switch, router, hub, microprocessor, network access point, or any other device.

Also, disclosed herein is a method for optical data communication with an optic module and a host. In one embodiment, this method includes receiving an incoming optic signal from an optic fiber and converting the incoming optic signal to an incoming electrical signal. This method then amplifies the incoming electrical signal with a transimpedance amplifier and provides the amplified incoming electrical signal via an electrical interface to the host.

In the host, this method performing processing with a digital signal processor in the host to quantize the incoming electrical signal to two or more distinct logic levels. Next, processing an outgoing electrical signal with the digital signal processor signal located in the host and providing the processed outgoing electrical signal from the host to the optic module via the electrical interface. Then, amplifying the outgoing electrical signal to a level suitable for driving an optic signal generator and generating an outgoing optic signal representing the outgoing electrical signal. This optic signal is transmitted onto a fiber optic cable.

In one configuration, the digital signal processor located in the host processes signals for other optic modules thereby being shared between optic modules. It is contemplated that the transimpedance amplifier may be configured to perform de-emphasis processing to de-emphasis certain frequencies of the incoming electrical signal. Similarly, optic device driver may perform equalization with an equalization module equalize certain frequencies of the outgoing electrical signal. To achieve numerous benefits, the optic module may be configured without a digital signal processor. The host may be one or more of the following devices: server, switch, router, hub microprocessor, network access point, or any other data communication device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an example environment of use of the innovations disclosed herein.

FIG. 2 is an exemplary optic module 204 that electrically connects to a data communication device.

FIG. 3 illustrates a block diagram of a prior art optic module and communication device.

FIG. 4A illustrates block diagram of an example embodiment with the DSP located in the communication device, such as a server, switch, router, hub, or any other device.

FIG. 4B illustrates an alternative embodiment in which a single DSP is shared between two or more optic modules 308.

FIG. 5 illustrates a block diagram of an example embodiment with the DSP located in the communication device with additional de-emphasis and/or pre-equalization processing in the TIA.

FIG. 6 illustrates a block diagram of an example embodiment with the DSP located in the communication device with equalization processing in the driver.

FIG. 7 illustrates the logic levels for a PAM4 signal and additional details for creating improved threshold levels

FIG. 8 illustrates an exemplary block diagram of an example method of logical level threshold calculation.

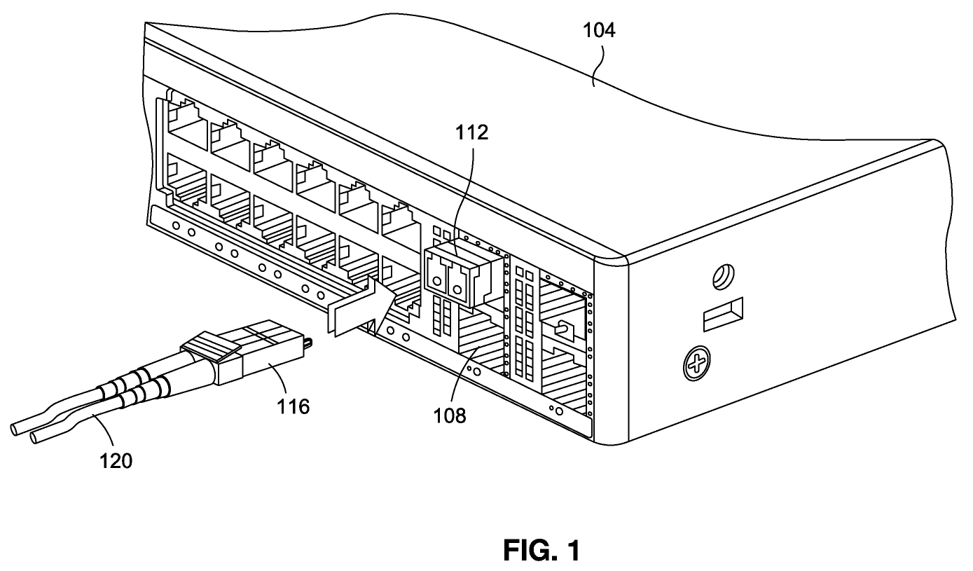

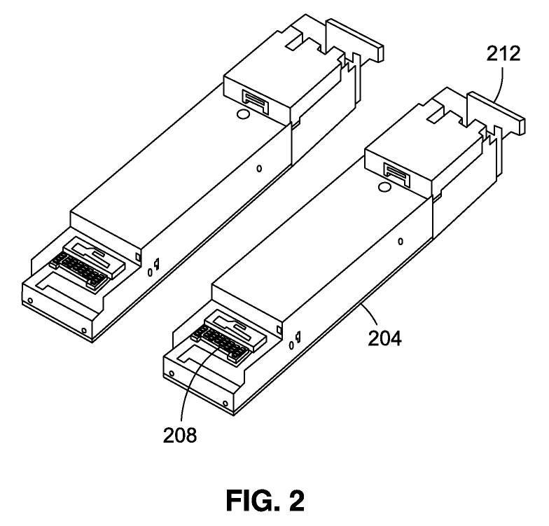

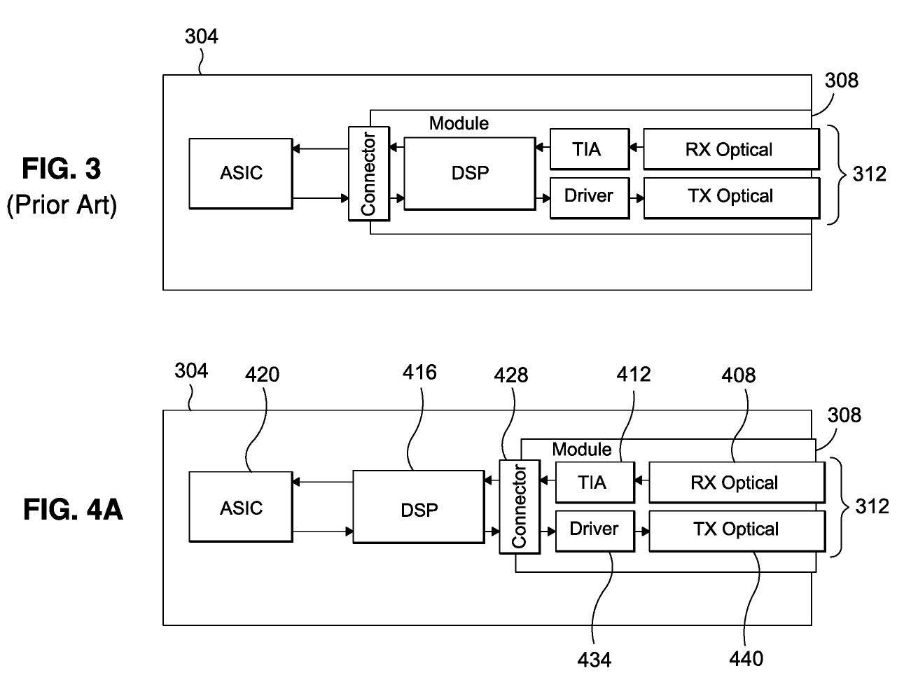

### DETAILED DESCRIPTION

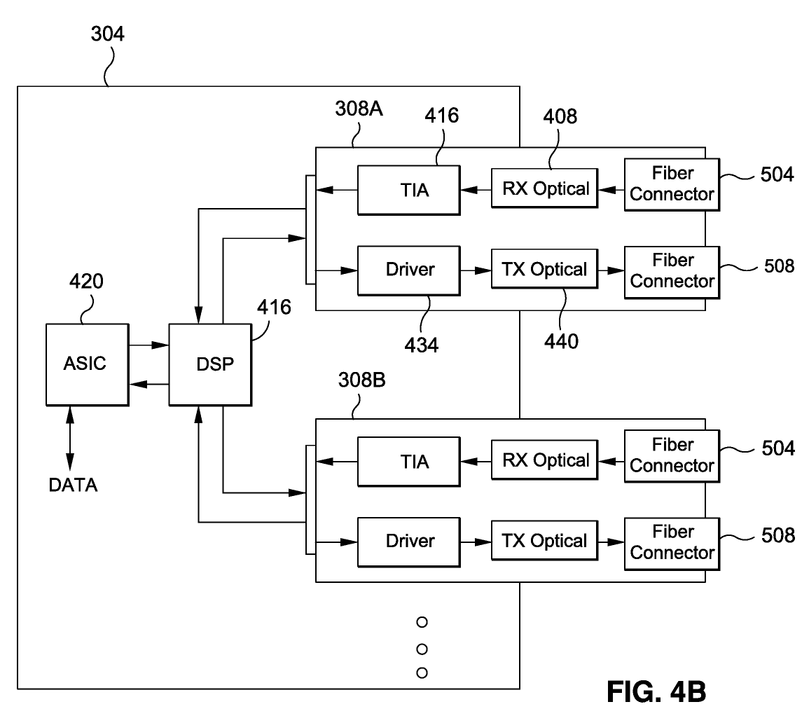

It is now proposed to not put the DSP in the module. By removing the DSP from the module, power dissipation within module is roughly half of the prior art arrangement and no margin stacking for expensive DSP chip occurs. FIG. 4A illustrates an example embodiment with the DSP located in the communication device, such as a server, switch, router, hub, or any other device. As shown in FIG. 4A, a host 304 receives an optic module 308. The host 304 may be any devices configured to receive an optical module and process electrical signal therefrom. The host 304 may comprise any of the following, or any combination of the following: switch, router, computer, server or other electronic device 104 capable of data communication.

Incoming optical signals are provided to the RX optical unit 408 which receives and processes optic signals to an electrical format. The output of the RX optical unit 408 feeds into a transimpedance amplifier (TIA) 412. The TIA 412 amplifies the signal from the RX optical unit 408 to an amplified electrical signal. The resulting electrical signal is provided to the host 304 through an electrical connector 428.

As shown the DSP 416 is located in the host 304 and is configured to receive and process the electrical signal from the connector 428. DSP 416 processing may include but is not limited to decision feedback equalization, feed forward equalization, signal slicing/quantization, or any other signal processing now known or developed in the future. The output of the DSP 416 is provided, in this embodiment, to an application specific integrated circuit (ASIC) 420 or any other processing element configured to process the signal as part of data communication protocols.

The system shown in FIG. 4A is also capable of converting electrical signals to optic signals and transmitting the optic signals over an optic fiber or other medium. To perform signal transmission, the ASIC 420 and DSP 416 processes an electrical signal and thereafter provide the signal to be transmitted via the connector 428 to a driver 434. The driver prepares the electrical signal to a suitable magnitude and format for driving an optic signal generator, such as a laser, that is part of a TX optical unit 440. The TX optical unit 440 generates an optic signal representing the electrical signal, and provides the optic signal to a fiber optic cable.

The embodiment of FIG. 4A has numerous advantages over the prior art. One advantage is that this embodiment lowers the cost of the optic module 308 by relocating the DSP 416 to the host 304. As a result, the optic module is made less expensive. Margin stacking contributes to the cost such that the DSP manufacture marks up the price of the DSP to realize a profit, as does the distributor of the DSP. Likewise, the optic module stacks on some profit as the optic module distributor. Finally, the seller or reseller of the optic module will also mark up the optic module. This causes the DSP to be marked up several times thereby stacking each profit margin in the product chain to thus increase the cost of the DSP in the optic module to the end user. Typically, a single host 304 will include ports for multiple optic modules, thereby necessitating the purchase of a single host, while tens of optic modules may be required. By placing the DSP in the host, the overall the system cost is reduced. In addition, the end of life term for an optic module 308 typically being less than that of a host 304, due to the optic signal generators burning out or becoming out of specification. Thus, the optic modules 308 must be replaced more often due to aging and failure than the host, which results in further cost savings since the optic modules, which cost less without the DSP, having to be replaced more often than the host.

In addition, it is less costly to configured the DSP in the host with more processing power (as compared to a DSP located in the optic module), thereby allowing it to be shared by multiple optic modules, than to have separate lower processing power DSP's located in each optic module. This is because greater functionality or processing power in one chip is less expensive that two different chips with the same or similar capability when combined. Stated another way, one powerful device typically costs less than two less powerful devices.

A further advantage is reduced power consumption and heat generation by the optic module which previously had challenges maintaining ideal operating temperature due to location and nature of construction.

FIG. 4B illustrates an alternative embodiment in which a single DSP is shared between two or more optic modules 308. As compared to FIG. 4A, identical elements are labeled with identical reference numbers. The discussion of duplicate elements are not discussed again and the disclosure from FIG. 4A is incorporated with FIG. 4B. In the embodiment of FIG. 4B, the DSP 516 located in the host 304 is shared between two or more optic modules 308A, 308B. As such, compared to a DSP being placed in each optic module 308A, 308B, a single DSP 416 is shared, thereby reducing the number costly DSPs that are required for a system. In other embodiments, additional optic modules 308 may share a DSP 416, which was moved from the optic module to the host 304

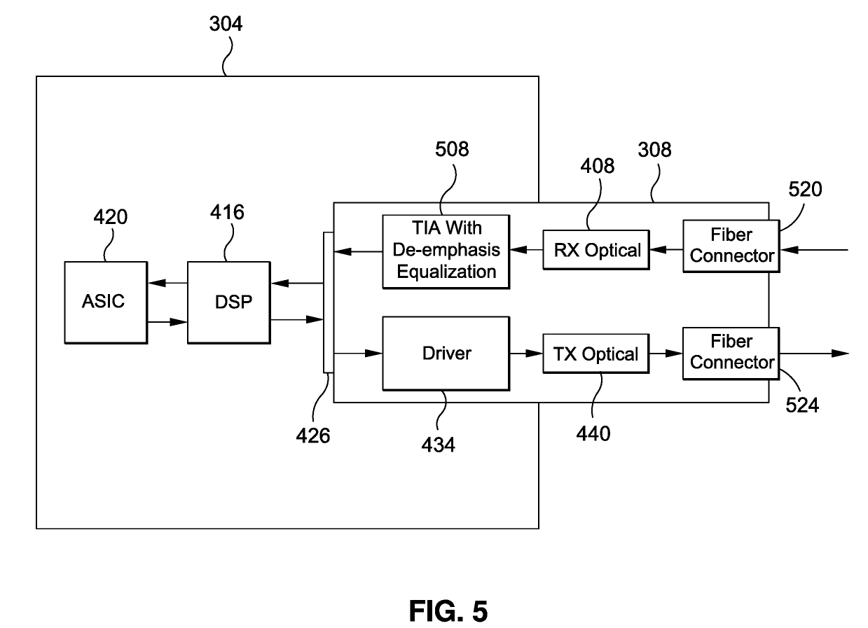

FIG. 5 illustrates a block diagram of an example embodiment with the DSP located in the communication device with additional de-emphasis and/or pre-equalization processing in the TIA. The embodiment of FIG. 5 is generally similar to the embodiments of FIGS. 4A and 4B and as such, only the elements of FIG. 5 which differ from FIG. 4 are discussed. The discussion of FIG. 4A and 4B is incorporated for FIG. 5.

The fiber optic cable (with connector) plugs into the fiber connector 520. As shown, the TIA 508 is configured to de-emphasis equalization, which may also be referred to herein as pre-equalization. The TIA with de-emphasis equalization is configured to compensate for the losses in the connector. In one configuration, pre-emphasis refers to a system process designed to increase (within a frequency band) the magnitude of some frequencies, typically higher frequencies, with respect to the magnitude of other frequencies in order to improve the overall signal-to-noise ratio by minimizing the adverse effects of the signal path or other phenomena, such as attenuation or distortion. De-emphasis type equalization is known in the art and as such it is not described in detail herein. It is contemplated to use the TIA with de-emphasis may account for a poor quality signal being offloaded to the communication device DSP 416. It is proposed to de-emphasize low frequency but in other embodiment, other frequency ranges or bands may be de-emphasized. This effect may be considered as pre-distorting to account for the off-module DSP. Also proposed is TIA with pre-equalization functions, which is similar to de-emphasis but may affect the signal in other ways. This will account for loss and distortion in TIA and the sending of the signal through the optic module, the optic module connector and into the communication device. Pre-equalization functions are known in the art and not described in detail herein.

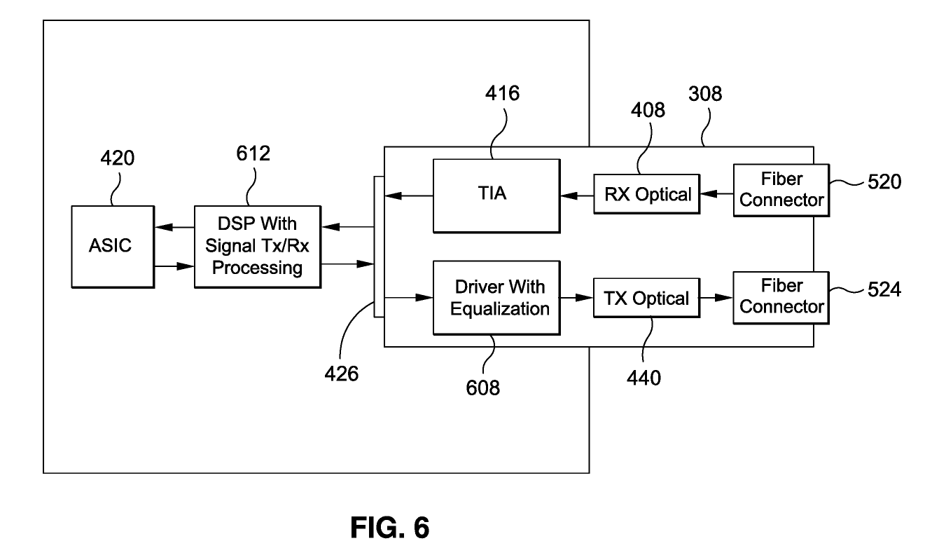

FIG. 6 illustrates a block diagram of an example embodiment with the DSP located in the communication device with equalization processing in the driver. The embodiment of FIG. 6 is generally similar to the embodiments of FIGS. 4A and 4B and as such, only the elements of FIG. 6 which differ from FIGS. 4A and 4B are discussed. The discussion of FIGS. 4A and 4B is incorporated for FIG. 6. In this embodiment, the driver 608 is configured with an equalization module to perform equalization on the electrical signal to compensate for the effects of the electrical signals passage through connector 426 and the trace between DSP 612 and the driver. It is also proposed to perform DSP processing to compensate for the losses in the connector. The DSP processing can occur on either or both of the transmit path or receive path to account for the resulting effects on the signal from having the DSP in the communication device instead of the module.

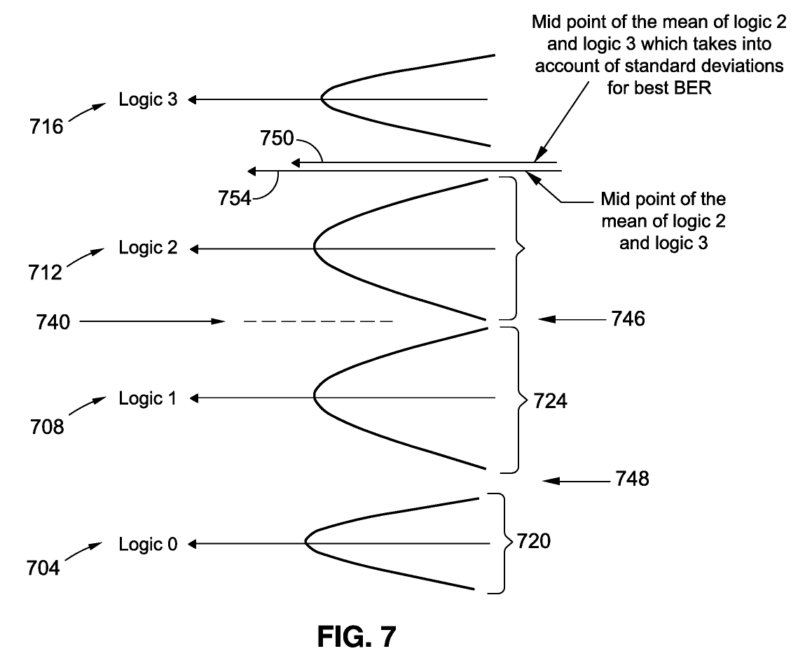

Also, proposed is a new and novel method for determining slice point levels and threshold for determining signal values in a received signal. FIG. 7 illustrates the logic levels for a PAM4 signal in relation to establishing improved threshold levels. In this example embodiment, there are four logic levels, namely, logic level 0 704, logic level 1 708, logic level 2 712 and logic level 3 716. Magnitude is shown in a vertical direction. Received signals that have a magnitude in the range 720 while receive signals having a magnitude in the range of 724. This pattern repeats as is understood in the art. The average DC level 740 is defined as the level between logic level 1 708 and logic level 2 712. The threshold levels are defined the magnitudes above or below which received signals are sliced to a different logic level. For example, in FIG. 7, there is threshold 0-1, which is the threshold magnitude between logic level 0 704 and logic level 1 708. Received signal having a magnitude below magnitude 748 are sliced (quantized) to logic level 0 704. Likewise, threshold level 1-2 746 separates logic level 1 708 and logic level 2 712.

As can be seen in FIG. 7, the span of signal values 720 is not as high as the span of signal magnitudes 724. This is how typical slice threshold levels are calculated based on signal distribution over time. Prior art methods for calculating thresholds often used the mean 754 of received signal as the midpoint (threshold) between logic levels. Disclosed below is a novel method for calculating a threshold 750 between logic levels which is more accurate and based on mean and standard deviation.

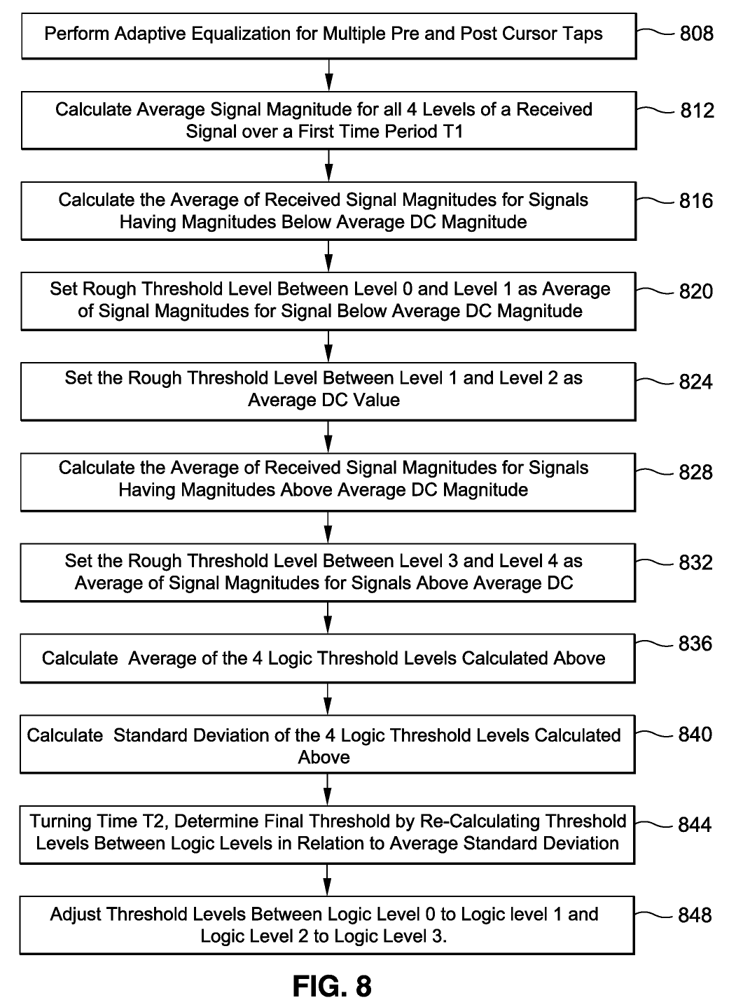

FIG. 8 is a flow chart of the steps for calculating more accurate slide points. Discussed below is the system and method for a PAM4 signal, but the same principles may be applied to any multilevel signal level determination. This is but on example method of operation and other method are contemplated that do not depart from this concept. At a step 808, this method performs adaptive equalization for multiple pre-and post-cursors taps occurs. This may occur in the DSP. Then at a step 812 the method calculates the average signal magnitude of all 4 levels of a receives signal over or during a first-time period. This occurs in the following steps.

At a step 820, this method sets a rough threshold level between logic level 0 and logic level 1 as the average of the signal magnitudes for the received signals below the average DC magnitude. Then, at a step 824 the rough threshold level is set between logic level 1 and logic level 2 as the average DC value. Next, at a step 828 this method calculates the average of the received signal magnitudes for received signals having magnitudes above average DC magnitude. Consequently, at a step 832, this method of operation sets the rough threshold level between logic level 3 and logic level 4 as the average of the signal magnitudes for the received signals above average DC.

At a step 836 this method calculates the average of the 4 logic threshold levels based on the values calculated above in the prior steps. Similarly, at a step 840 based on the 4 logic threshold levels calculated above in the prior steps, the method calculates the standard deviation. The prior art methods did not utilize a standard deviation component. At a step 844, during a second time period T2, this method determines the final threshold by re-calculating the threshold levels between logic levels in relation to the average standard deviation. Accordingly, at step 848, the method adjusts the threshold levels between logic level 0 and logic level 1 and between logic level 2 to logic level 3. This provides more accurate thresholds between logic levels. This will guarantee best BER. Also contemplated is applying decision feedback equalization based on previous logic levels. This method may be based on a linear model or based on level by level history to take non-linearity into account.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An optic module and host configured for data communication comprising:
An optic module comprising;
a housing having an interior space;
a port configured receive an optical connector, the optical connector attached to a fiber optic cable which carries an optic signal;
a receiver optic unit configured to receive and convert the optic signal to a receiver signal;
a transimpedance amplifier configured to amplify the receiver signal to create an amplified signal and provide an incoming signal to the host;
a driver configured to receive and amplify an outgoing electrical signal to be transmitted as an electrical signal, the outgoing electrical signal received from the host;
a transmitter optic unit configured to receive and convert the amplifier version of the outgoing electrical signal from the driver to an optic signal, the optic signal transmitted from the transmitter optic unit;
a host comprising;
a port having an electrical interface, the port configured to receive the optic module and establish an electrical connection to the optic module;
a digital signal processor configured to:
receive and process the incoming electrical signal over the electrical interface from the optic module;
process a data signal to create the outgoing electrical signal and provide the outgoing electrical signal to the optic module through the electrical interface.

2. The optic module and host of claim 1 wherein the digital signal processor performs feed forward equalization, decision feedback equalization, or both.

3. The optic module and host of claim 1 wherein the digital signal processor in the host is shared between two or more optic modules.

4. The optic module and host of claim 1 wherein the transimpedance amplifier further comprises a de-emphasis module configured to de-emphasis certain frequencies of the receiver signal.

5. The optic module and host of claim 1 wherein the driver amplifier further comprises an equalization module configured to equalize losses in the path from the digital signal processor to the driver.

6. The optic module and host of claim 1 wherein the optic module does not include a digital signal processor.

7. The optic module and host of claim 1 wherein the host consists of one of the following devices: server, switch, router, hub, microprocessor, or network access point.

8. An optic module for use with a host comprising:
a port configured to accept an optical connector, the optical connector connected to one or more fiber optic cables which carry incoming optic signals and outgoing optic signals;
a receiver module configured to receive an incoming optic signal and convert the received optic signal to a received electrical signal;
a transimpedance amplifier configured to amplify the received electrical signal;
an electrical interface configured to electrically interface the optic module with the host thereby providing the amplified received electrical signal to a digital signal processor in the host;
an optic device driver configured to receiving and outgoing electrical signal from the host, after processing by a digital signal processor in the host, over the electrical interface such that the optic device driver is configured to amplify outgoing electrical signals; and
a transmit module configured to:
receive the outgoing electrical signal from the optic device driver;
convert the outgoing electrical signal to an outgoing optic signal; and
transmit the outgoing optic signal on an optic fiber associated with the optical connector.

9. The optic module of claim 8 wherein the optic module shares the digital signal processor located in the host with one or more other optic modules.

10. The optic module of claim 8 wherein the transimpedance amplifier further comprises a de-emphasis module configured to de-emphasis certain frequencies of the receiver signal.

11. The optic module of claim 8 wherein the optic device driver further comprises an equalization module configured to de-emphasis certain frequencies of the outgoing electrical signal.

12. The optic module of claim 8 wherein the optic module does not include a digital signal processor.

13. The optic module of claim 8 wherein the host consists of one of the following devices: server, switch, router, hub, microprocessor, or network access point.

14. A method for optical data communication with an optic module and a host comprising:
receiving an incoming optic signal from an optic fiber;
converting the incoming optic signal to an incoming electrical signal;
amplifying the incoming electrical signal with a transimpedance amplifier;
providing the amplifier incoming electrical signal via an electrical interface to host;
performing processing with a digital signal processor in the host to quantize the incoming electrical signal to two or more distinct logic levels;
processing an outgoing electrical signal with the digital signal processor signal located in the host;
providing the processed outgoing electrical signal from the host to the optic module via the electrical interface;
amplifying the outgoing electrical signal to a level suitable for driving an optic signal generator;
generating an outgoing optic signal representing the outgoing electrical signal; and
transmitting the outgoing optic signal onto a fiber optic cable.

15. The method of claim 14 wherein the digital signal processor located in the host processes signal for other optic modules.

16. The method of claim 14 wherein the transimpedance amplifier also performs de-emphasis processing to de-emphasis certain frequencies of the incoming electrical signal.

17. The method of claim 14 wherein the optic device driver further comprises an equalization module configured to de-emphasis certain frequencies of the outgoing electrical signal.

18. The method of claim 14 wherein the optic module does not include a digital signal processor.

19. The method of claim 14 wherein the host consists of one of the following devices: server, switch, router, hub, microprocessor, or network access point.
